(19) United States
(12) Patent Application Publication
(10) Pub. No.: US 2002/0120698 A1
(43) Pub. Date: Aug. 29, 2002

(54) Method and system for emergency electronic communication network

(76) Inventor: J. William Tamargo, Jacksonville, FL (US)

Correspondence Address: NIXON & VANDERHYE P.C., 8th Floor, 1100 North Glebe Road, Arlington, VA, 22201-4714, US

(21) Appl. No.: 09/988,220

(22) Filed: Nov. 19, 2001

Related U.S. Application Data
(60) Provisional application No. 60/252,263, filed on Nov. 20, 2000.

(51) Int. Cl. G06F 15/173; G06F 15/16

(52) U.S. Cl. 709/206; 709/224

(57) ABSTRACT

A method, system, and computer program processes for electronically delivering risk analyzed crucial information. The invention includes the electronic delivery of emergency information to individual recipient members of a constituency group and across unrelated constituency groups to provide the recipient members with information designed to assist the recipients in the protection of self and property, to provide for recipient well being and to minimize liability to recipients or third parties who accept liability on behalf of recipients. The information is obtained from a variety of sources which the system analyzes and prioritizes to provide the maximum benefit.

### RELATED APPLICATION

Priority is claimed to U.S. provisional application No. 60/252,263, filed Nov. 20, 2000, the entire of which is incorporated by reference.

### FIELD OF INVENTION

The invention disclosed broadly relates to communications systems, and more particularly relates to a method and system for electronic messaging, content creation and sending. In particular, a method and system is disclosed for providing information via electronic messaging in crucial or emergency situations.

### BACKGROUND OF THE INVENTION

Electronic mail (e-mail) and other types of electronic messages are becoming extremely popular. Business and personal users increasingly rely on electronic messages as a communications medium to be notified of situations that affect them and to obtain information. The increasing amount of information available in electronic form coupled with the reliability, cost saving and speed of electronic messaging makes this an effective medium to provide businesses and personal users with information notification services that may have a direct impact on their personal well being, safety, health, security, financial or otherwise, and the protection of their personal property.

In general, the sheer volume of information sources available, the overwhelming task of locating such sources, the determination of which information sources are most relevant to one's business or personal well being, the disparate nature and format of content from varying sources and the ease of availability of the relevant information to be delivered by electronic messaging make the process of obtaining the information a daunting task for the user.

Therefore, there is a need in the art of electronic messaging for an improved method for accessing information sources, analyzing them, prioritizing them and sending electronic messages in situations where the information may directly impact one's personal or financial well being and protection, the protection of relatives and friends and the protection of personal property. This needed method should provide a new and improved interface for obtaining content from a variety of sources; determining the content source's relevance, risk to well being and impact to the recipient user; and allocating and prioritizing the electronic message sending and redistribution function in order to provide the most benefit and good. Such improvements find further utility in situations where personal or business well being is impacted by emergency situations.

### SUMMARY OF THE INVENTION

To satisfy the above-described needs, an improved system and method has been developed for the development of an electronic messaging infrastructure capable of locating, accessing and evaluating content from multiple sources which provide relevant content, prioritizing the sending and redistributing the content to users using an electronic messaging network. The system and method further provides a resulting benefit to users in the form of information and content capable of assisting in maintaining the user's well being, protection, safety, financial and personal security in the normal course of day to day existence as well as in times of imminent threat or emergency.

The present method and system further provides for the sending of electronic messages to multiple groups or groupings of electronic messaging addresses, the assignment of a sending hierarchy to such groups or groupings based on the authority level of a sender, and a priority sending order based on electronic message content as it relates to the recipients well being or the risk thereto.

The system includes a messaging network having computer servers, databases, content location and access components, multiple data source access components, message content analysis and risk analysis components, a user interface component, and a sender interface.

A sender interface component provides for the simultaneous preparation, examination and manual authoring of multiple electronic messaging content formats to accommodate multiple messaging device receiving requirements.

A user recipient interface component provides for the single entry of a user's electronic address or e-mail address, zip code, county or geographically-identified facility or entity into the address delivery database such that the recipient becomes eligible to receive content from all sources whose sending authority includes such geographically-described recipient.

In one embodiment the invention is an electronic messaging method utilizing a computer server electronically linked to at least one source of data and to a communication network for communicating with individuals, said method comprising the steps of: monitoring the at least one source of data for content information related to risk events; analyzing the content information to identify risk events related to a group of said individuals, and issuing an electronic message regarding the risk to said group.

In another embodiment the invention is an electronic messaging system comprising: a computer server electronically linked to a plurality of data sources, each of said data sources having content information regarding risk events; said computer server including an access control program to collect said content information from said data sources, a scope analyzer program to match one or more of said risk events to one or more groups of subscribers to the electronic messaging system, and a content engine that generates electronic messages regarding said one or more of said risk events and sends said messages to said one or more groups of subscribers via a communications network.

In a further embodiment, the invention is a method for subscribing and receiving emergency electronic messages from a computer network comprising the steps of: accessing a computer terminal to enter information regarding a subscriber including a geographic address and an electronic address of the subscriber; storing the information regarding said subscriber in a subscriber database linked to said network, wherein said database includes information regarding a plurality of subscribers; monitoring a plurality sources of data for content information related to risk events; analyzing the content information and the subscriber database to identify a risk event geographically proximate to the geographic address of one or more of the subscribers, and issuing an electronic message regarding the risk event to said one or more subscribers proximate to the event.

This method may further include generating a second electronic message regarding a second risk before completing the issuance of a first electronic message regarding a first risk; determining that the second electronic message has priority over the first electronic message, and suspending issuance of the first electronic message while issuing the second electronic message.

The various aspects of the present invention may be more clearly understood and appreciated from a review of the following detailed description of the disclosed embodiments and by reference to the appended drawings.

### BRIEF DESCRIPTION OF THE DRAWINGS

FIG. 1 is a block diagram depicting the overall processing of information according to one embodiment of the present invention.

FIG. 2 is an illustration of a user interface for the public sender interface.

FIG. 3 is an illustration of a user interface for the public user interface.

### DESCRIPTION OF THE PREFERRED EMBODIMENTS

Overview

An emergency electronic messaging and e-mail system is disclosed comprising a) a server, b) an interface to data sources, c) a database, d) a sender interface, and e) a public user interface whereby the server accesses and stores emergency information and the public user can access said emergency information.

The invention utilizes a computer network server and processes to automatically access and assess multiple data sources and determine the degree to which the data sources content has the potential to protect the well being of individuals, singly or as a group and to provide such information to individuals. In addition to providing information from multiple data sources, the system utilizes a direct public sender interface which permits the manual creation and automatic sending of content by public officials and constituent group authorities across multiple related or unrelated groups of constituent electronic messaging recipients.

Multiple Data Sources

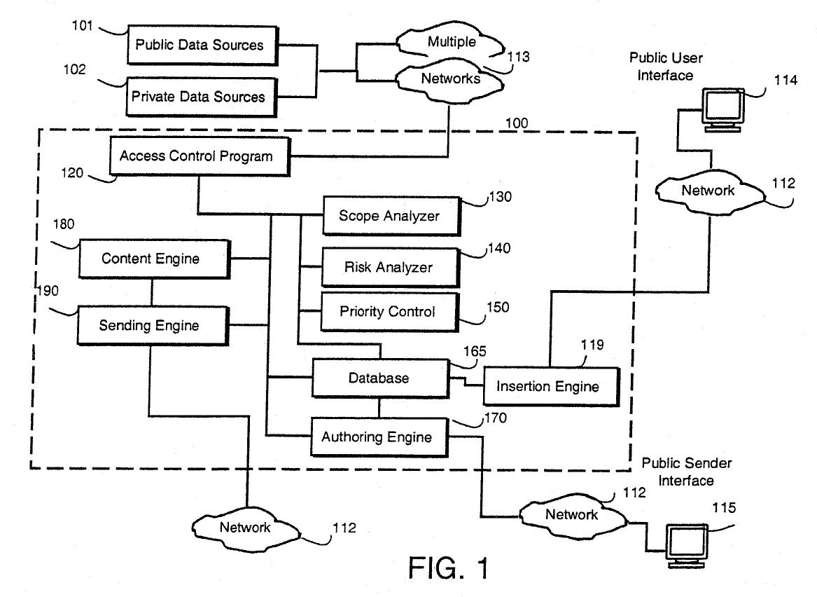

As shown in FIG. 1, the system includes a standard server 10 for a computer network. A server having one or more central processing units, memory, physical data storage and networking connectivity. In one preferred embodiment the server is connected to multiple networks 112 and 113 through an interface connection. An example of one preferred embodiment provides for the server to be network connected to the Internet and to a continuous data feed network by hardwired or wireless connections to networks.

The server executes software program code to perform various processes embodied within the invention to be described in greater detail below. The server accesses information from multiple data sources, such as both public 101 and private 102 data services. Content information is obtained from these multiple data sources by the server 100 over networks 113 by using an access control program 120. The access control program determines which data sources will be accessed based on a list of eligible data sources. The access control program 120 uses multiple protocols which correspond to the protocols required by the various data sources which it is accessing in order to capture data from each data source. Exemplary protocols utilized by the access control program are polling and continuous data stream protocols.

In one embodiment, the access control program determines the priority in which multiple data sources are accessed by assessing the data source based on the data sources expected content. Such a priority is preset within program code in the access control program, entered by a user via a user interface or determined by a rule table. In one example of the embodiment the access control program first accesses U.S. Geological Survey data source, and then of U.S. National Weather Service data source.

In another embodiment, the access control program within the server utilizes polling protocols to obtain information from data sources. The access control program in the server determines the polling sequence and polling frequency of polled data sources that it accesses. Polling sequence and frequency are determined by a set of polling access rules. Polling rules are preset within program code in the access control program, entered by a user via a user interface or determined by a rule table. The polling rules relate the polling frequency and polling sequence (i) to the type of content being obtained from the data source and/or to (ii) an analysis of the data content's impact and scope in affecting the ultimate recipients of the content. As in the case of content sources where content to be received by the ultimate recipients has the potential to provide for the recipients personal or financial well being, security, protection from loss, limitation of loss or liability, the polling frequency and sequencing of data sources are determined to achieve that end. The access control program may analyze continuous data stream(s) of data sources. The polling processes may be carried out by multiple servers geographically or topographically disbursed on a communications network.

Content obtained from data sources utilizing the access control program is passed to a scope analyzer software application 130. The scope analyzer software program determines if the content in the data source pertains to geographical or functional groups within the database 165 of recipients and further determines the impact scope of the content. The scope refers to the magnitude of the content's ability to minimize total risk, financial loss, personal safety and personal well being across the total database 165 of recipients.

In another embodiment, the scope analyzer program scans content sources to identify any information within content source that describes or names a scope to which the content relates. The risk analyzer performs a byte by byte scan of the content. The content scope name or description is compared to an equivalent scope descriptor in the scope analyzer program that provides geographical and population table data permitting a further assessment of the contents impact in a subsequent process to be described in more detail below.

The information and content are further analyzed by a risk analyzer 140 process which analyzes the content to determine its potential to impact and/or minimize total risk, financial loss, personal safety and personal well being. The risk analyzer performs a byte by byte scan of the content. The risk analyzer scans the content to determine from the information within the content the potential of the content to minimize total risk and financial loss, risk to personal safety, health and personal well being. The risk analyzer performs the determination within program code in the risk analyzer, from information entered by a user via a user interface or determined by a rule table. In one embodiment the risk analyzer determines a dollar value or human loss associated with the scope.

The information concerning the scope obtained from the scope analyzer and information concerning risk obtained from the risk analyzer is associated with the data sources content for further processing. In one example the scope information and risk information are numerically coded and associated with the data source content in a table.

Information obtained from the scope analyzer 130 and the risk analyzer 140 is utilized by the priority control process 150 to dynamically sequence the preparation and the sending of the content to recipients whose e-mail addresses are contained within the database 165.

In one embodiment the content that has been obtained from the multiple data sources and analyzed by the scope analyzer and risk analyzer is then aggregated by the content engine 180. The content engine 180 prepares electronic message content containing the data source content then passes the content to the sending engine 190 which utilizes scope information to access and send to those e-mail addresses that are represented by the multiple constituency groups within the scope and the risk based priority information to determine the order in which messages are sent through a network 112. In one embodiment the sending engine 190 utilizes a standard SMTP server connected to the Internet.

In another preferred embodiment the content that has been obtained from the multiple data sources and analyzed by the scope analyzer and risk analyzer is then aggregated by the content engine 180 to produce a web document (e.g., an informational electronic file posted on the Internet world-wide-web had an Internet site) containing the data source content, then passes the web document to the sending engine 190 connected to a network 112. In this embodiment the sending engine utilizes a file transfer protocol (FTP) to publish the web document by transferring the web document to a web site or multiple sites. The sending engine utilizes scope analyzer and risk analyzer information to determine the scope and sequence of the web document multiple site transfers over the network.

In another embodiment the priority control 150 process can dynamically control the sending engine 190 by re-sequencing the sending of messages being processed by the sending engine. In a description of one example of this embodiment the priority control 150 is called to process new information and content that has been processed by the scope analyzer 130 and the risk analysis process in which the content has been determined to have greater priority and scope relative to risk and well being than content already in the process of being sent by the sending engine. In this case the priority control 150 can dynamically re-sequence those messages being sent by the sending engine to favor the sending of those messages containing the more recently processed content over those messages it is already in the process of sending.

Public Sender Interface

The electronic messaging system may utilize a public sender interface 115, 112, 170. The public sender interface comprises a method of utilizing a terminal 115 connected by a network 112 to manually enter and compose a message and to initiate the sending of the message.

The terminal may be a web browser, e.g., a software program for interacting with information sites on the Internet world-wide-web (www), connected to the server 100 by a network 112. The public sender enters user identification and password allowing access to the public user interface, and the authoring engine. When authorized, the user is permitted the right to execute the sending of a message utilizing the system and the network.

Upon being granted successful access, the authorized sender is given the access and control to compose and send an electronic message across a multitude of organizationally related or organizationally unrelated constituency groups. The public sender interface determines the scope of the public senders sending authority by the user identification and password of the public sender.

The authorized sender may be a person within a single organizationally related constituency group to whom is granted the authority to communicate crucial or emergency information to the constituency group. For example, the authorized sender is a public official communicating with citizens. In another example the authorized sender is an emergency manager communicating with citizens. In another example, the authorized sender is a risk manager of an insuring entity communicating with potential claimants. In still another example the authorized sender is a school superintendent communicating with parents and students.

Although the above description contains specific examples, these should not be construed as limiting the scope of the invention, but as merely providing illustrations of some of the preferred embodiments. Many variations are possible and are to be considered within the scope of the present invention.

There are a variety of devices capable of receiving electronic messages or e-mail. Many devices have limitations with respect to the number, amount and size of the electronic messages the device is capable of receiving, storing or displaying. In order to effectively communicate crucial or emergency content using electronic messages to a variety of devices, a method for the composition of alternate message formats is necessary. The invention utilizes an authoring engine 170 which interfaces to the public sender.

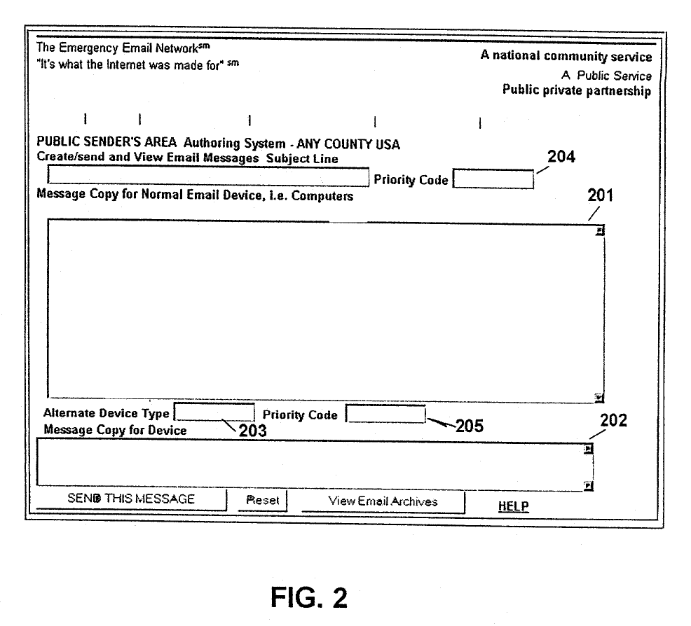

The public sender interface may utilize an authoring engine 170 which accepts alternate message content from an authorized sender. FIG. 2 illustrates one example of the authoring engine interface. The authoring engine provides a singular method of drafting, preparing and routing messages in alternate formats 201, 202 and assigning the format to a device type 203 for sending to the designated device type.

In one example, the sender composes a message in which the substance of the message content is similar from one device to another but must be abbreviated to be properly received, read and interpreted by a recipient with a pager type of device. The sender specifies a device type and composes the message content specific to the specified device type. The sender initiates the sending process by an action to do so utilizing a keystroke or a mouse click.

In another embodiment, the authoring engine accepts a priority code 204, 205 from the sender at the time of message composition to be used to prioritize the sending of the message based on the device type for which the message is being composed and sent. The system then prepares and sends the messages to those devices having higher priorities than other devices utilizing the priority analyzer described in greater detail below.

The authoring engine, from the information supplied by the sender relating to device type, message content format and priority, analyzes the device type, message content, message content format and priority designation to determine the priority of message preparation and sending by the system. The authoring engine suspends its analysis if the sender provides an input overriding the actions of the authoring engine.

In one example the sender specifies a device type, device one, such as a pager and composes message content to be accepted and displayed by such device, and additionally prepares a message with similar content but in an alternate format to support a second device type such as a computer generally capable of receiving and displaying more robust message content. The authoring engine determines the priority of each of the messages based on the device type.

Public User Interface

The database 165 may contain the electronic message addresses and e-mail addresses of information recipients provided by the server from the remote data sources and the public sender interface described prior.

The public user interface 114,112 and the insertion engine 119 inserts recipients electronic message addresses into the database 165. The public user interface comprises a method of utilizing a terminal 114 connected by a network 112 to manually enter a recipients electronic message address.

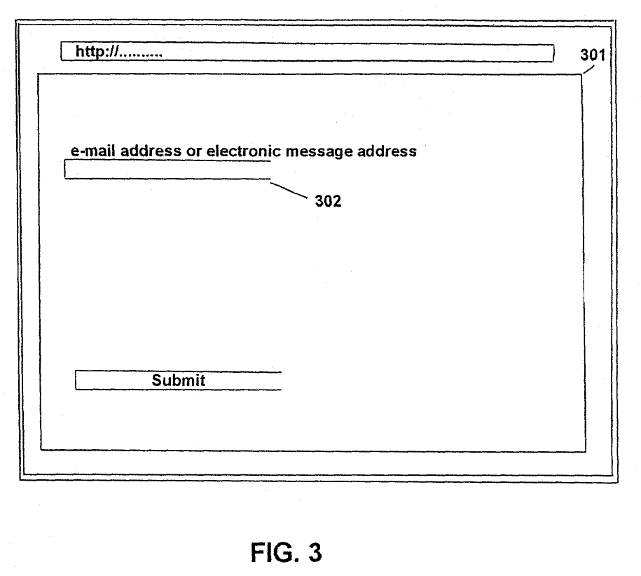

The terminal 114 may be an Internet capable device connected to the server 100 by a network 112. The terminal accepts an e-mail or electronic address from the user who enters the address on a web page FIG. 3. Utilizing the submission of a single entry of the address 302 and the web page 301 utilized by user for entry, the insertion engine 119 interprets the user address and automatically inserts the address into a multitude of related and unrelated constituency group structures within the database.

The combination of the current web page on which the address is being entered and the entry of a single address by the user may all that it is required of the insertion engine when the information is submitted.

In an alternate embodiment, the insertion engine utilizes the electronic address and other data supplied and entered by the user which identifies characteristics of the user which the insertion engines then uses to automatically insert the address into a multitude of related and unrelated constituency group structures within the database.

The database may be a distributed database across a network. In this embodiment, the insertion engine determines into which network topologic and geographic location and multiple constituency structures across the distributed database the electronic address should be inserted.

One such constituency structure may be a public national geographical group structure comprised of country, state, county, city, community, voting precinct, census district zip code. Upon entry of the address, the address is automatically inserted by the insertion engine into a multitude of the constituency structures. The insertion engine also inserts the address into unrelated constituency structures within the database.

One example of an unrelated constituency group structure is the American Red Cross. The American Red Cross constituency group structure is unrelated to the public national constituency group structure. A user supplies and enters an electronic e-mail address on a web page designated for the unrelated constituency group. Upon entry the insertion engine inserts the address into the public national group structure and the unrelated constituency group.

Another example of an unrelated constituency group structure is the Boy Scouts of America. The Boy Scouts of America constituency group structure is unrelated to the public national constituency group structure. A user supplies and enters an electronic e-mail address on a web page designated for the unrelated constituency group. Upon entry the insertion engine inserts the address into the public national group structure and the unrelated constituency group.

Another example of an unrelated constituency group structure is a school system comprised of teachers, schools and school districts. The school system constituency group structure is unrelated to the public national constituency group structure. A user supplies and enters an electronic email address on a web page designated for the unrelated constituency group. Upon entry the insertion engine inserts the address into the public national group structure and the unrelated constituency group.

Although the above description contains specific examples, these should not be construed as limiting the scope of the invention, but as merely providing illustrations of some of the preferred embodiments of this invention. Many variations are possible and are to be considered within the scope of the present invention.

What is claimed is:

1. An electronic messaging method utilizing a computer server electronically linked to at least one source of data and to a communication network for communicating with individuals, said method comprising the steps of:
a. monitoring the at least one source of data for content information related to risk events;
b. analyzing the content information to identify risk events related to a group of said individuals, and
c. issuing an electronic message regarding the identified risk event to said group.

2. An electronic messaging method as in claim 1 wherein in step (a) the at least one source of data includes a plurality of data sources, and in step (b) the plurality of data sources are regularly monitored for content information.

3. An electronic messaging method as in claim 1 wherein the monitoring of at least one data source is performed continually.

4. An electronic messaging method as in claim 1 wherein the monitoring of at least one data source is performed by periodically polling the data source.

5. An electronic messaging method as in claim 1 wherein the identification of the risk event is performed by a scope analyzer that determines if the content information relates to said individuals.

6. An electronic messaging method as in claim 1 wherein the monitoring of at least one data source includes sequentially monitoring a plurality of data sources in accordance with a data source polling priority determined by an access control program.

7. An electronic messaging method as in claim 6 wherein the access control program employs a plurality of polling protocols for accessing the plurality of data sources.

8. An electronic messaging method as in claim 6 wherein the access control program determines the polling priority based at least in part on the content information in each of said plurality of data sources.

9. An electronic messaging method as in claim 6 wherein the access control program determines a polling frequency for each of said plurality of data sources.

10. An electronic message method as in claim 9 wherein the access control program determines the polling frequency based on an expected impact of the risk event upon the individuals.

11. An electronic message method as in claim 1 wherein analyzing the content information is performed with a scope analyzer.

12. An electronic message method as in claim 11 wherein the scope analyzer correlates content information with one or more of said individuals.

13. An electronic message method as in claim 1 wherein the individuals are subscribers to an electronic message service.

14. An electronic message method as in claim 1 further comprising the step (e) of repeating steps (a) to (b) to generate a second electronic message regarding a second risk before completing the issuance of a first electronic message regarding a first risk; (f) determining that the second electronic message has priority over the first electronic message, and (g) suspending issuance of the first electronic message to issue the second electronic message.

15. An electronic messaging system comprising:
a computer server electronically linked to a plurality of data sources, each of said data sources having content information regarding risk events;
said computer server including an access control program to collect said content information from said data sources, a scope analyzer program to match one or more of said risk events to one subscriber of the electronic messaging system, and a content engine that generates electronic messages regarding said one or more of said risk events and sends said messages to said one or more groups of subscribers via a communications network.

16. An electronic messaging system as in claim 15 wherein the computer server further comprises a risk analyzer that prioritizes said one or more risk events, and causes said content engine to first issue said messages regarding a high priority risk event.

17. An electronic messaging system as in claim 15 wherein said scope analyzer includes protocol routines for accessing said data sources.

18. An electronic message system as in claim 15 wherein said scope analyzer periodically polls each of said data sources.

19. An electronic message system as in claim 15 wherein said scope analyzer continually monitors each of said data sources.

20. An electronic message system as in claim 15 wherein said scope analyzer polls said data sources at a polling frequency dependent on a priority assigned to each of said data sources.

21. An electronic message system as in claim 15 wherein said data sources are remote from the server, and a wide area network links said data sources to said server.

22. An electronic message system as in claim 21 wherein said wide area network is an Internet.

23. An electronic message system as in claim 15 wherein said data sources include a geological activity survey data source and a weather data source.

24. An electronic message system as in claim 15 wherein said content engine is electronically linked to a public sender interface, wherein said interface includes a user terminal to accept manual entry of messages to be sent by the content engine.

25. A method for subscribing and receiving emergency electronic messages from a computer network comprising the steps of:
a. accessing a computer terminal to enter information regarding a subscriber including a geographic address of the subscriber and an electronic address of the subscriber;
b. storing the information regarding said subscriber in a subscriber database linked to said network, wherein said database includes information regarding a plurality of subscribers;
c. monitoring a plurality sources of data for content information related to risk events;
d. analyzing the content information and the subscriber database to identify a risk event geographically proximate to the geographic address of one or more of the subscribers, and
e. issuing an electronic message regarding the risk event to said one or more subscribers proximate to the event.

26. A method for subscribing and receiving emergency electronic messages as in claim 25 wherein said subscriber database is a preexisting database of subscribers to an organization.

27. A method for subscribing and receiving emergency electronic messages as in claim 26 wherein said preexisting database of subscribers is a plurality of databases of subscribers to different organizations.

28. A method for subscribing and receiving emergency electronic messages as in claim 25 wherein the plurality of data sources are periodically polled for content information.

29. A method for subscribing and receiving emergency electronic messages as in claim 25 wherein the plurality of data sources are continually monitored for content information.

30. A method for subscribing and receiving emergency electronic messages as in claim 25 wherein the identification of the risk event is performed by a scope analyzer that determines if the content information relates to one or more groups of subscribers.

31. A method for subscribing and receiving emergency electronic messages as in claim 25 wherein the monitoring of data sources includes sequentially monitoring of data sources in accordance with a data source polling priority determined by an access control program.

32. A method for subscribing and receiving emergency electronic messages as in claim 25 further comprising the step (f) of repeating steps (c) to (e) to generate a second electronic message regarding a second risk before completing the issuance of a first electronic message regarding a first risk; (g) determining that the second electronic message has priority over the first electronic message, and (h) suspending issuance of the first electronic message to issue the second electronic message.

33. An electronic messaging method utilizing a computer server electronically linked to at least one source of data and to a communication network for communicating with individuals, said method comprising the steps of:
a. monitoring the at least one source of data for content information related to risk events;
b. analyzing the content information to identify risk events related to a group of said individuals;
c. generating a first electronic message regarding the identified risk event to said group, wherein said first electronic message is intended for a first type of electronic communication device;
d. generating an alternative electronic message regarding the identified risk event to said group, wherein said alternative electronic message is intended for a second type of communication device;
e. sending the first electronic message to those individuals of said group known to have the first type of electronic communication device, and
f. sending the second electronic message to those individuals of said group known to have the second type of electronic communication device.

34. An electronic messaging method as in claim 33 further comprising the step of prioritizing such that messages to the first type of electronic communication device are sent before messages sent to the second type of electronic communication device.

35. An electronic messaging method as in claim 34 wherein prioritization is determined, at least in part, based on the type of electronic communication device to receive the message.

36. An electronic messaging method as in claim 33 further comprising the steps of determining a message priority based on electronic communication device, and prioritizing such that messages to one type of electronic communication device are sent before messages sent to another type of electronic communication device.

37. An electronic messaging method as in claim 33 wherein said first type of electronic communication device is a pager and the second type of electronic communication device is a computer.
